(19) United States
(12) Patent Application Publication
(10) Pub. No.: US 2025/0289514 A1
(43) Pub. Date: Sep. 18, 2025

(54) INFLATABLE AERODYNAMIC DEFLECTOR FOR CONVEYANCES

(71) Applicant: Tesla, Inc., Austin, TX (US)

(72) Inventors: Adrian Gael Lamy, Hayward, CA (US); Westbrook Morrill, Santa Clara, CA (US)

(21) Appl. No.: 19/060,282

(22) Filed: Feb. 21, 2025

Related U.S. Application Data
(60) Provisional application No. 63/565,998, filed on Mar. 15, 2024.

(51) Int. Cl. B62D 35/00; B60Q 1/00; B62D 27/06

(52) U.S. Cl. CPC B62D 35/007; B62D 27/06; B60Q 1/0017

(57) ABSTRACT

An inflatable aerodynamic deflector to reduce drag and enhance efficiency. Constructed from drop stitch material, it forms one or more air chambers between parallel skins. The component includes a pressure regulation mechanism and diverse attachment interfaces such as rail systems, magnetic fasteners, and quick disconnect clips, distributed along the vehicle for secure mounting. This component acts as an aerodynamic deflector, optimizing airflow around conveyances, especially combination vehicles like tow vehicles and trailers.

### CLAIM FOR PRIORITY

This application claims the benefit of priority to U.S. Provisional Application No. 63/565,998, filed Mar. 15, 2024, which is hereby incorporated by reference in its entirety.

### TECHNICAL FIELD

Examples of the present disclosure relate generally to the field of vehicle aerodynamics and transportation engineering. More specifically, the disclosure pertains to aerodynamic enhancement devices designed to reduce drag and improve fuel efficiency for various types of conveyances, including but not limited to road vehicles such as passenger cars, commercial trucks, and trailers.

### BACKGROUND

The transportation sector is a significant contributor to global energy consumption, with a substantial portion of this energy being used to overcome aerodynamic drag in various types of vehicles. Aerodynamic drag is a force that opposes the motion of a vehicle through the air, and it increases with the square of the vehicle's speed. As such, reducing drag is a critical factor in enhancing the energy efficiency of vehicles, particularly those that operate at highway speeds where the effects of drag are more pronounced.

Historically, the design of vehicles, especially commercial trucks and trailers, has prioritized factors such as capacity, durability, and cost-effectiveness, often at the expense of aerodynamic efficiency. This has led to vehicles with shapes that are not optimized for airflow, resulting in higher fuel or energy consumption and increased emissions or a reduction of range in the context of electric vehicles (EV), wherein range refers to a maximum distance an EV can travel on a single charge of its battery.

Efforts to improve vehicle aerodynamics have included various approaches, such as the use of fixed aerodynamic structures and the refinement of vehicle body shapes. However, these solutions often involve trade-offs between aerodynamic performance and other design considerations, such as the ease of manufacturing, vehicle weight, and the flexibility of use in different driving conditions.

Furthermore, the dynamic nature of vehicle operation, which involves varying speeds, loading conditions, and maneuvers, presents additional challenges in achieving optimal aerodynamics across all scenarios. There is, therefore, an ongoing need for adaptable aerodynamic solutions that can respond to changing conditions and maintain efficiency without compromising other vehicle performance attributes.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagram depicting an inflatable aerodynamic deflector, according to certain examples.

FIG. 2 is a diagram depicting an inflatable aerodynamic deflector in a deployed state, according to certain examples.

FIG. 3 is a diagram depicting a method of applying a contour curve to a drop stitch material, according to certain examples.

FIG. 4 is a diagram depicting a method of applying a contour curve to a drop stitch material, according to certain examples.

FIG. 5 is a diagram depicting an inflatable aerodynamic deflector, according to certain examples.

FIG. 6 is a diagram depicting a drop stitch material, according to certain examples.

### DETAILED DESCRIPTION

The present disclosure describes an approach to enhancing the aerodynamic performance of conveyances through the use of an inflatable aerodynamic deflector. This component is designed to be integrated with a variety of vehicles, including but not limited to, passenger cars, commercial trucks, and trailers, to reduce aerodynamic drag and improve fuel efficiency and energy consumption.

In the realm of transportation engineering, the significance of aerodynamic drag on a vehicle's performance is well-established. Drag is a resistive force that acts opposite to the relative motion of the vehicle with respect to the surrounding air. At higher speeds, such as those encountered on highways, the impact of aerodynamic drag on fuel consumption becomes increasingly substantial. Traditional vehicle designs have often prioritized structural strength, cargo capacity, and cost-effectiveness, with less emphasis on optimizing aerodynamic properties. As a result, many vehicles on the road today are not as aerodynamically efficient as they could be.

To address this inefficiency, the disclosed inflatable aerodynamic deflector offers a dynamic solution that can be adapted to the specific needs of the vehicle and the conditions under which it operates. The component is characterized by an air chamber formed from a drop stitch material, which includes a pair of skins connected by yarns. This structure allows the component to maintain its shape and stiffness when inflated, even under the high-pressure conditions experienced during vehicle operation, Including withstanding significant aerodynamic loads and high-pressure conditions that arise during the operation of the vehicle at various speeds, particularly at highway velocities where wind forces are most substantial. The materials and construction of the deflector are selected and engineered to endure these stresses without deformation. The internal architecture of the deflector, which may include features such as tensioned yarns or reinforcing struts within the air chambers, is optimized to distribute and resist the forces encountered, thereby maintaining the aerodynamic efficiency and structural integrity of the component throughout its use.

In some examples, the yarns, or threads, that connect the pair of skins are woven, interlacing with the layers to maintain a fixed distance between them. This weaving process allows for a durable and uniform structure that can be inflated to form a rigid component.

In some examples, the yarns are positioned between the skins and are bonded to the skins at predetermined points. The bonding process, which may include heat sealing or heat bonding techniques, secures the yarns in place and ensures the integrity of the air chamber when the material is inflated.

The inflatable aerodynamic deflector is further equipped with an inflation valve to facilitate inflation and deflation, enabling quick adaptation to varying aerodynamic requirements. Attachment interfaces are distributed along the perimeter of the component, allowing for secure and straightforward integration with corresponding fixtures on the vehicle or conveyance.

For example, as depicted in the corresponding diagrams, the drop stitch material that forms the core of the inflatable aerodynamic deflector consists of two distinct layers of fabric and a series of woven yarns.

One of the fabric layers constitutes an outer surface of the drop stitch material and may be crafted from a selection of durable and flexible materials, chosen for their ability to endure the dynamic forces of vehicular movement and the rigors of environmental exposure.

The second fabric layer is positioned parallel to the first, with both layers encapsulating the woven yarns. This second layer shares similar robust and flexible characteristics, ensuring that the material inflates uniformly and maintains structural stability.

The yarns woven between the two fabric layers define the distance between the layers, which in turn dictates the thickness of the inflatable aerodynamic deflector. By adjusting the length of these yarns, the thickness of the deflector can be customized to meet specific aerodynamic needs.

In some examples, the inflatable component comprises one or more contour edges. For example, the contour edge may be formed by fabricating the skins of the drop stitch material with different areas. For example, an external, or outer skin may be made with a larger surface area than an inner, or internal skin. When the component is inflated, the larger area of the external skin accommodates a greater volume compared to the internal skin, resulting in a contoured edge. This edge can be designed to follow specific aerodynamic profiles that reduce drag, such as a teardrop shape or other streamlined forms.

In some examples, the one or more contour edges may be formed by varying the thread pitch of the yarns that connect the two parallel skins of the drop stitch material. By adjusting the distance between the yarns at specific locations, the material can be tailored to form contoured edges. For example, a tighter thread pitch can be used in areas where a sharper edge is desired, while a looser pitch can create a more gradual curve. This method allows for precise control over the shape of the inflatable component, enabling customization for different vehicle designs and aerodynamic requirements.

In some examples, the one or more contour edges are formed by cutting and removing a segment from one or more of the skins of the drop stitch material. After the desired segment is removed, the edge is sealed back together, which can be done through taping, welding, or using adhesives. This cut-and-seal method allows for the creation of complex shapes and contours that are not easily achievable through uniform inflation alone.

In some examples, the inflatable aerodynamic deflector comprises a leading edge and a trailing edge, wherein the leading edge of the component, which is the foremost part that first interacts with the airflow as the vehicle moves, is constructed to be thinner than the trailing edge.

The reduced thickness at the leading edge reduces the frontal area of the component that comes into contact with the air, thereby reducing the initial resistance or drag encountered. In some examples, the variation in thickness from the leading edge to the trailing edge is achieved by varying the length of the yarns that connect the two parallel skins of the drop stitch material. By adjusting the yarn length, the internal volume and, consequently, the external shape of the inflatable component can be precisely tailored. The yarns are shorter near the leading edge, creating a thinner profile, and gradually increase in length towards the trailing edge, resulting in a thicker profile.

In some examples, the inflatable aerodynamic deflector is characterized by a planar form that is defined by the air chamber created by the pair of parallel skins. The planar form refers to a generally flat shape of the component when viewed from the side, which is achieved when the component is in a fully inflated state. The parallel skins, which are connected by yarns in a drop stitch pattern, are designed to inflate to a specific tension that results in a flat or planar surface.

In some examples, the inflatable aerodynamic deflector features edges that transition into continuous curves, here referred to as “contoured edges,” which are symmetrically arranged in relation to the component's central longitudinal axis. These contoured edges are crafted by configuring the parallel skins and the interconnecting yarns to adopt a curved trajectory, akin to a segment of a circle defined by a specific radius and center point, upon inflation of the component. Accordingly, by varying the thread pitch of the yarns that interconnect the two parallel skins of the drop stitch material, or strategically adjusting the spacing between the yarns, the material can be customized to form precise contoured edges, with tighter thread pitches for sharper edges and looser pitches for more gradual curves. This enables the inflatable component to be tailored to meet the aerodynamic demands of different vehicle designs and driving conditions.

Additionally, contour edges can be formed by a cut-and-seal process, where segments of one or more of the skins are removed and then resealed using methods such as taping, welding, or adhesives. This process allows for the creation of complex shapes that enhance the aerodynamic efficiency of the deflector beyond what is possible with uniform inflation alone.

In certain examples, the deflector is designed with a leading edge and a trailing edge, where the leading edge—the part of the component that first encounters airflow—is intentionally made thinner than the trailing edge. This design reduces the frontal area that interacts with the air, thereby minimizing the initial aerodynamic resistance. The variation in thickness from the leading to the trailing edge is finely controlled by altering the length of the yarns connecting the skins. Shorter yarns near the leading edge result in a slimmer profile, while longer yarns towards the trailing edge create a thicker profile, allowing for a tailored shape that optimizes the vehicle's aerodynamic performance.

In some examples, the inflatable aerodynamic deflector is configured to be attached to a conveyance. The component is equipped with one or more attachment interfaces that correspond to fixtures located at the forward end of the conveyance. These fixtures are positioned to facilitate the secure attachment of the inflatable component and are engineered to withstand the aerodynamic forces encountered during conveyance operation.

For example, the inflatable component may serve as an aerodynamic deflector to redirect airflow around the conveyance to minimize aerodynamic drag. The deflector can be positioned at various locations on the conveyance, such as the front, sides, or rear, to address specific aerodynamic challenges. For example, the deflector may include one or more attachment interfaces that align with and attach to pre-existing fixtures on the conveyances front or rear end. These fixtures may be strategically placed to ensure a robust connection of the inflatable component, capable of withstanding the dynamic aerodynamic forces during the operation of the conveyance.

In some examples, the inflatable component may be configured for use with combination vehicles, which consist of a tow vehicle and a trailer. The component can be used to improve the aerodynamic interface between the tow vehicle and the trailer, reducing the aerodynamic drag experienced by the combination vehicle.

Accordingly, when the component is deployed and inflated, it creates a streamlined shape that helps to guide the airflow around the conveyance more efficiently. By optimizing the shape of the forward end with the inflatable component, the conveyance can achieve better fuel economy or increased electric range due to the reduced aerodynamic resistance.

In some examples, the inflatable aerodynamic deflector is configured for attachment to the rearward end of a conveyance. Similar to the forward end application, such examples include attachment interfaces that match with corresponding fixtures at the rear of the conveyance. These fixtures are designed to accommodate the inflatable component and to maintain its position even at high speeds or under varying environmental conditions.

The purpose of these examples is to reduce the aerodynamic resistance at the rearward end of the conveyance, which is often characterized by turbulent wake and increased drag. The inflatable component, when inflated, modifies the shape of the rear end to smooth out the airflow and minimize the wake region. This can significantly decrease the drag coefficient of the conveyance, leading to improvements in energy efficiency.

In some examples, the inflatable aerodynamic deflector includes a deployment mechanism that can be either automated or manually operated, enabling it to be extended into its functional position or retracted for stowage. The specific design of the deployment mechanism can include systems such as motorized reels, pneumatic actuators, or manual cranks. These systems ensure that the deflector can be smoothly transitioned between its deployed and stowed configurations, adapting to the vehicle's aerodynamic needs as required.

In some examples, the deployment mechanism features a furling drum. The furling drum houses an internal furling foil around which the inflatable component is wound when not in use. The furling foil serves as the core structure to which the inflatable component is affixed. When deployment is desired, the furling foil rotates (either automatically or manually), allowing the inflatable component to unfurl and extend from the drum. Conversely, when the component needs to be stowed or retracted, the rotation of the furling foil retracts the component back into the drum.

In some examples, the deployment mechanism incorporates one or more bi-stable structures, which are designed to transition between two stable states: a retracted state for stowage and an extended state for deployment. A bi-stable structure is inherently stable in both positions, requiring no continuous power to maintain its state, thus ensuring reliability and energy efficiency.

For example, the bi-stable structure may include a spring-loaded deployment system, akin to the retraction mechanism of a tape measure. This system would consist of a motorized reel equipped with a high-tensile, flexible band that can coil within a housing when not in use. The band, made of durable materials such as metal or composite, is tensioned in such a way that it may be coiled into a compact form, similar to a tape measure's retraction mechanism.

Accordingly, upon activation, an electric motor unwinds the reel, releasing the tensioned band and allowing it to extend to its full length. Once in the extended state, the band locks into place, providing a stable framework onto which the inflatable aerodynamic deflector is secured and maintained in its operational position. Similarly, to retract the deflector, the motor reverses its direction, winding the band back onto the reel and leveraging the inherent tension within the band to return it to its compact, coiled state. The deployment mechanism is designed to provide a quick and efficient method of transitioning the inflatable component between its stowed and deployed states, as well as providing a means of setting a desired height (i.e., vertical dimension) of the inflatable component. This can be particularly useful in situations where the aerodynamic needs of the conveyance change rapidly, such as transitioning from highway speeds to urban driving conditions. The furling drum mechanism ensures that the inflatable component can be deployed or retracted with minimal effort and without the need for manual intervention.

The furling drum and foil system can be manually operated, or powered by various means, including electric motors, pneumatic systems, or hydraulic actuators, depending on the specific requirements of the application.

In some examples, the furling foil features a conical rail design. For example, in the context of a wedge-shaped inflatable aerodynamic deflector, the conical rail furling foil provides a mechanism to extend or retract the inflatable component. For example, the wedge shape of the component means that its height increases from the leading edge to the trailing edge, creating a shape that is taller at one end.

The conical rail within the furling drum accommodates the wedge shape by providing a variable diameter around which the inflatable component is wound. At the leading edge, where the component is thinner, the diameter of the conical rail is smaller. As the rail extends towards the trailing edge, its diameter increases to match the greater height of the component. This design ensures that the inflatable component can be wound tightly and evenly around the rail without any excess material or uneven tension that could lead to damage or improper deployment.

In some examples, at least one of the pair of parallel skins of the inflatable component is translucent. This translucent skin allows light to pass through, which can be utilized for both aesthetic and functional purposes. The integration of a lighting system within the air chamber of the inflatable component takes advantage of the translucent properties of the skin to illuminate the component.

For example, the lighting system may be integrated within the air chamber, incorporating LED lights, fiber optics, or other appropriate light-emitting elements that are strategically positioned to produce the intended lighting effect. In another example, the lighting system is mounted on the conveyance itself, adjacent to one edge of the inflatable component. This configuration enables light to be transmitted in a direction perpendicular to the skins, enhancing the illumination of the inflatable aerodynamic deflector. The lighting systems in both examples can be powered by an electrical system associated with the conveyance, and managed through the vehicle's onboard computer or a specialized control unit.

In some examples, the yarns used to connect the pair of parallel skins in the inflatable component are made from reflective materials. This feature allows the yarns to reflect light, which can enhance the visibility of the component, particularly in low-light conditions. The reflective quality of the yarns can contribute to the safety of the conveyance by increasing its detectability to other road users.

Accordingly, by illuminating the inflatable component, the vehicle's visibility is enhanced, particularly in low-light conditions or at night. This can increase safety by making the vehicle more noticeable to other road users. The lighting can be designed to emit colors that are commonly associated with vehicle lighting, such as white for the front, red for the rear, and amber for the sides. The lighting system can be used to communicate information to other road users. For example, it can indicate turning or braking, by changing colors or patterns.

In some examples, the inflatable component is equipped with one or more attachment interfaces to facilitate secure and quick attachment to the conveyance. These interfaces are designed to accommodate different types of fixtures on the conveyance and can be selected based on the specific application and requirements. For example, the interfaces may include one or more of: a rail system; magnetic fasteners; quick disconnect clips; dovetail joints; snap fasteners; and buckles and clips.

In some examples, the inflatable aerodynamic deflector includes a pump, an air compressor, or combination of both, that forms part of a pressure regulation mechanism. The air compressor is responsible for inflating the air chamber of the component to the desired flow rate and pressure. Sensors and a central processing unit can automatically control the air compressor to adjust the inflation level based on factors such as vehicle speed, wind conditions, and other environmental factors.

In some examples, the pressure regulation mechanism may be designed to be removably connectable to the inflatable component. This could be achieved by incorporating a built-in connecting valve into the inflatable component itself, which would allow for the attachment of an external air compressor. Such a design would enable the use of separate inflating devices, such as the onboard compressors found in some modern vehicles. The connecting valve would facilitate a secure and efficient connection to the compressor that is part of the vehicle's system, allowing for convenient inflation and deflation as needed. A connecting valve would serve as the interface between the inflatable component and the external pressure source, ensuring that the pressure regulation mechanism can be easily accessed and operated, whether for maintenance, adjustment, or storage purposes

In some examples, the pressure regulation mechanism may include a digitally controlled air compressor that can inflate or deflate the component in response to real-time data from aerodynamic sensors. These sensors may measure parameters such as airspeed, vehicle acceleration, and ambient air pressure, allowing the system to adjust the component's inflation level for maximum efficiency. Additionally, the mechanism may also include feature a series of electronically operated valves that can rapidly release air to quickly reduce the component's volume in response to sudden changes in vehicle dynamics or in preparation for stowing the component. For redundancy and manual override, a mechanical pressure relief valve may also be incorporated, ensuring safety and control in the event of system failure. Furthermore, the pressure regulation mechanism may be integrated with the vehicle's telematics system, enabling remote monitoring and adjustment of the component's pressure settings via a secure wireless connection, providing fleet operators with the ability to optimize aerodynamic performance across their vehicles in real-time.

In some examples, the pressure regulation mechanism may include a manual air compressor, which can be manually operated to inflate the air chamber to the desired pressure. To assist the operator in achieving the correct inflation level, the pressure regulation mechanism may include a mechanical pressure gauge and a manual inflation valve, which is compatible with standard air compressor hoses. This valve provides a secure and leak-resistant connection for air transfer. A manual bleed valve may also be provided to release air incrementally, allowing for precise deflation and adjustment of the component's pressure. In some examples, the inflatable component comprises multiple air chambers, wherein each chamber can be inflated to a different pressure, allowing for the creation of complex shapes and the ability to adjust the aerodynamic properties of the component in response to changing conditions. For example, the chambers may be interconnected with valves to allow for pressure equalization or can be individually sealed to maintain different pressures.

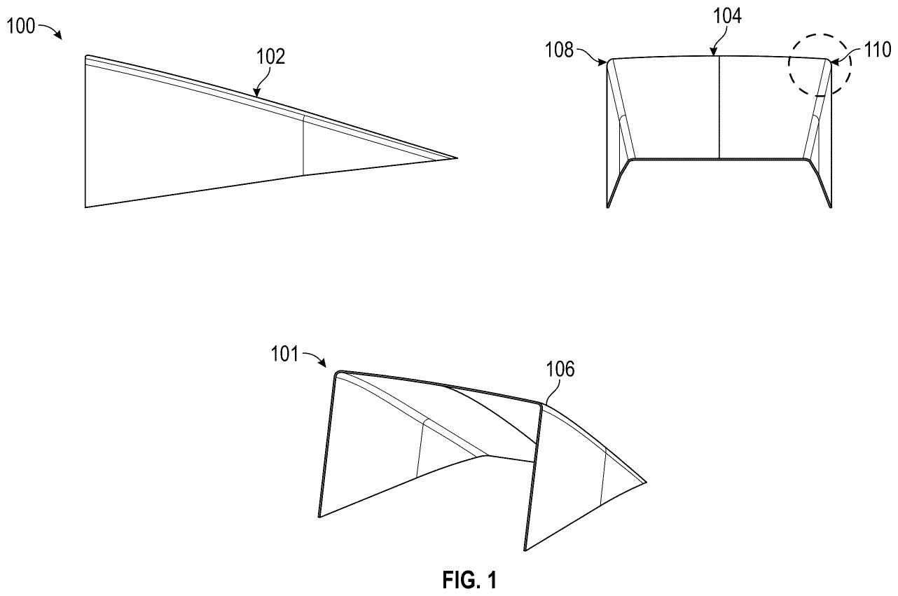

FIG. 1 is a diagram 100 depicting an inflatable aerodynamic deflector 101, according to certain examples. As seen in FIG. 1, the diagram 100 includes a profile view 102 of an inflatable aerodynamic deflector, a rear view 104 of an inflatable aerodynamic deflector 101, and a rear isometric view 106 of an inflatable aerodynamic deflector. According to certain examples, the inflatable aerodynamic deflector 101 may comprise a central rectangular panel that transitions into two triangular, wedge-shaped panels extending perpendicularly from the lateral edges of the central rectangular panel.

As seen in the profile view 102, the inflatable aerodynamic deflector 101 may comprise a wedge shape, wherein the leading edge of the inflatable aerodynamic deflector 101 corresponds with a tapered end. Accordingly, the rearward end of the inflatable aerodynamic deflector 101 may correspond with the trailing edge. In some examples, the trailing edge may be broader than the leading edge, contributing to the overall wedge shape of the component.

In certain examples, the inflatable aerodynamic deflector achieves the wedge shape by including two triangular panels that extend perpendicularly from the lateral edges of the central rectangular panel, and wherein the central rectangular panel and two triangular panels are achieved by applying at least two contour curves (e.g., contour curves 108 and 110) upon a planar surface formed of the drop stitch material. The curves may be achieved through a precise arrangement and tensioning of the yarns within the drop stitch material, which allows the component to maintain its shape when inflated.

As seen in the rear view 104, the contour curves 108 and 110 are aligned with a longitudinal axis of the inflatable aerodynamic deflector.

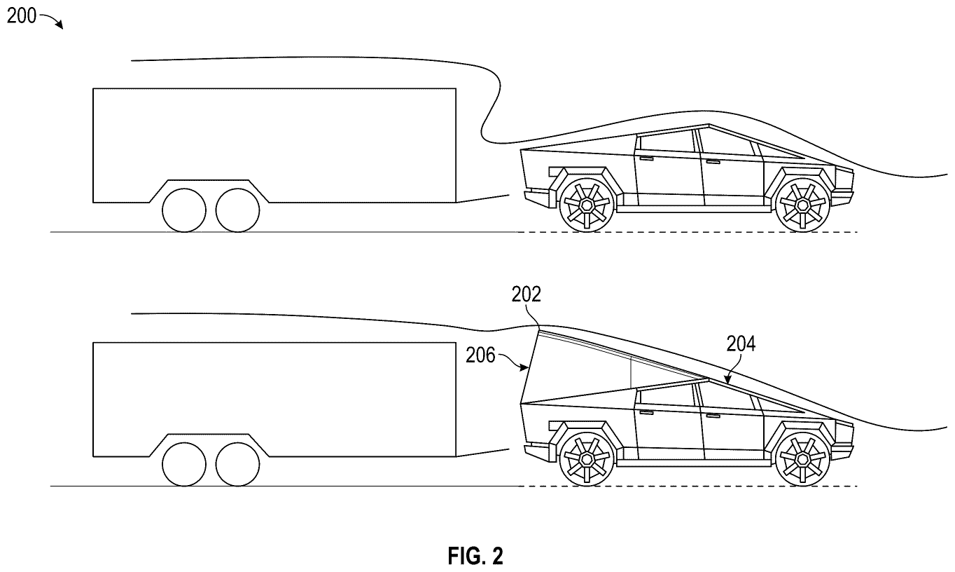

FIG. 2 is a diagram 200 depicting an inflatable aerodynamic deflector 202 in a deployed state, according to certain examples.

As seen in FIG. 2, the inflatable aerodynamic deflector 202 may be mounted on a conveyance 204 to reduce aerodynamic drag, wherein the conveyance 204 may include a combination vehicle (e.g., a truck and trailer). According to certain examples, a vertical dimension 206 of the inflatable aerodynamic deflector 202 may be modified or adjusted based on attributes of the conveyance 204, such as a height of a trailer. Accordingly, the inflatable aerodynamic deflector 202 may be mounted to optimize the airflow between the truck and the trailer, potentially at the rear of the truck cab or the front of the trailer, to smooth the transition of air from one to the other.

In certain examples, the leading edge of the central rectangular panel, along with the peripheral edges of the triangular panels that extend from the sides of the rectangular panel, are configured to align with the surface features of the conveyance. This alignment ensures a seamless interface between the inflatable aerodynamic deflector and the conveyance, reducing any disruptions in airflow and improving the aerodynamics of the conveyance.

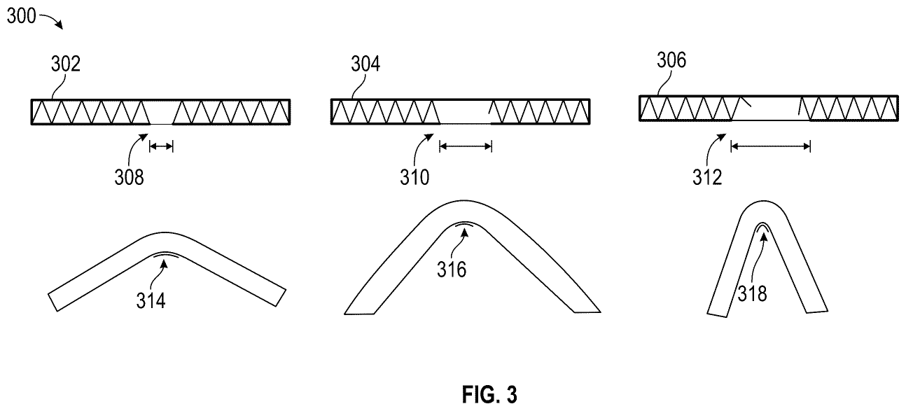

FIG. 3 is a diagram 300 depicting a method of applying a contour curve to a drop stitch material, according to certain examples.

The drop stitch material consists of two parallel layers of fabric that are connected by multiple threads or yarn. When inflated, the material forms a rigid structure due to the tension in these yarns. FIG. 3 provides a depiction of cross sections 302, 304, and 306—each representing a method of achieving a contour curve by the cutaway 308, 310, and 12, and resulting in a contour curve 314, 316, and 318.

Accordingly, cross section 302 corresponds to the narrowest removed section 308. The resulting contour curve 314 corresponds with the widest angle among the shown examples, demonstrating that a width of the angle corresponds with a width of the section removed.

As seen in cross section 304, the removal of section 310 corresponds with the curve 316, depicted as a mid-width angle, demonstrating that as the width of the section increases, the width of the angle of the curve 316 decreases, resulting in a more pronounced curve.

Finally, cross section 306 corresponds to the widest removed section 312, which results in the contour curve 318, which is depicted as having the narrowest angle.

Accordingly, the angle of the contour curve increases as the width of the removed section decreases.

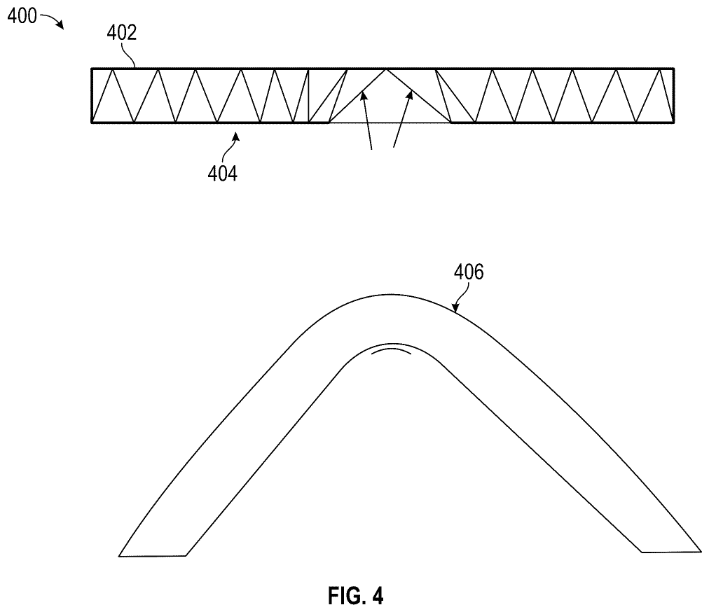

FIG. 4 is a diagram 400 depicting a method of applying a contour curve 406 to a drop stitch material 402, according to certain examples. As seen in FIG. 4, the drop stitch material 402 comprises two layers of fabric, wherein the two layers are held together and kept at a fixed distance by woven yarns 404, which protrude from the layers. In certain examples, the layers may be positioned parallel to each other or set at an angle, depending on the desired contour and aerodynamic requirements. Similarly, while the yarns may protrude perpendicularly from the fabric layers, they can also extend from the layers at various angles relative to the layers based on the desired shape.

According to certain examples, the contour curve 406 may be achieved by varying the thread pitch of the yarns 404 at specific areas of the material. The thread pitch refers to the distance between adjacent yarns within the material. By adjusting this distance, the contour of the material can be manipulated to create a desired shape when the material is inflated. For example, by varying the spacing between the yarns, the material can be tailored to inflate into a specific shape that conforms to the desired aerodynamic properties.

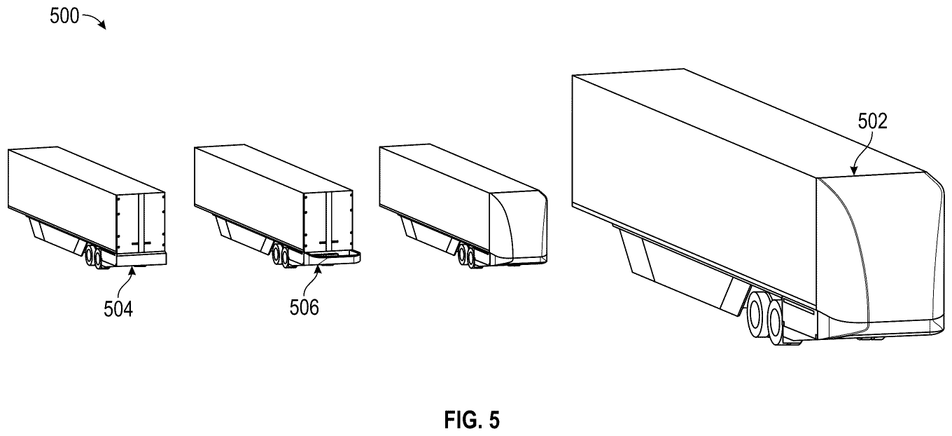

FIG. 5 is a diagram 500 depicting an inflatable aerodynamic deflector 502, according to certain examples. As discussed above, the inflatable component may function as an aerodynamic deflector, placed on a conveyance to reduce aerodynamic drag, and can be mounted at various points, including the front, sides, or rear, to address aerodynamic issues specific. Accordingly, the deflector is equipped with attachment interfaces that correspond to the conveyance's existing fixtures, ensuring a secure connection capable of enduring the dynamic forces encountered during travel.

Additionally, the inflatable component is adaptable for use with combination vehicles, such as those comprising a tow vehicle and a trailer. By optimizing the aerodynamic transition between these two elements, the component effectively diminishes the overall aerodynamic drag on the vehicle assembly.

As seen in FIG. 5, the inflatable aerodynamic deflector 502 may be configured to serve as a boat tail at the rear end of a trailer. A boat tail is an aerodynamic structure that extends from the back of a conveyance, such as a trailer, and in some example may taper to a point or a rounded end, effectively streamlining the airflow around the trailer's rear, thereby reducing turbulence and drag.

According to certain examples, the inflatable aerodynamic deflector may feature a base with a trapezoidal configuration, or more precisely, a trapezoid with rounded vertices to facilitate smoother airflow. This base may extend from the rear face of the conveyance, which is predominantly a flat rectangular surface, in a perpendicular or near-perpendicular orientation. The trapezoidal base serves as the foundational element from which the deflector rises upward.

The lateral sides of the deflector are shaped as spherical triangles, or “spherical sectors,” which emanate from the edges of the central panel. These spherical sectors curve inward, joining the central panel to create a unified aerodynamic surface. The central panel itself is approximately rectangular, to trapezoidal in shape, with its width at the base matching that of the upper edge of the trapezoidal base of the boat tail. As the panel extends upward, it widens towards the top, culminating in a wider leading edge, wherein the width of this leading edge is proportionally derived from the base width of the trapezoidal base.

While FIG. 5 depicts the inflatable aerodynamic deflector 502 as a boat tail affixed to a rear of a conveyance, according to certain examples, the inflatable aerodynamic deflector can be affixed to either the front or the rear of the conveyance, depending on the specific aerodynamic needs. When mounted on the front, the component acts as an air deflector, guiding the airflow around the conveyance to minimize resistance. Conversely, when attached to the rear, it functions as a boat tail, smoothing the airflow as it detaches from the conveyance, thus diminishing the wake and reducing drag.

In certain examples, the inflatable aerodynamic deflector 502 is designed to be stowed within a compartment 504 when not in use, conserving space and maintaining the conveyance's original profile for maneuvering in tight spaces or when aerodynamic benefits are not required, such as at low speeds.

The compartment 504 may retain the inflatable aerodynamic deflector 502 in a folded state within the component 504, which can be housed within a recess or a specially designed compartment on the conveyance. In some examples, the inflatable aerodynamic deflector 502 may include a deployment mechanism that comprises an automated system that is activated based on specific triggers, such as the conveyance reaching a predetermined speed threshold where aerodynamic efficiency becomes more beneficial.

For example, the automated deployment can be achieved through various means, including but not limited to, pneumatic, hydraulic, or electric actuators. These actuators would extend the component from its stowed position to its fully deployed aerodynamic configuration. Sensors integrated into the conveyance's control system can detect the appropriate conditions for deployment and trigger the actuators accordingly.

FIG. 5 provides a depiction 506 of the compartment in a deployed state, prior to deployment of the inflatable aerodynamic deflector 502.

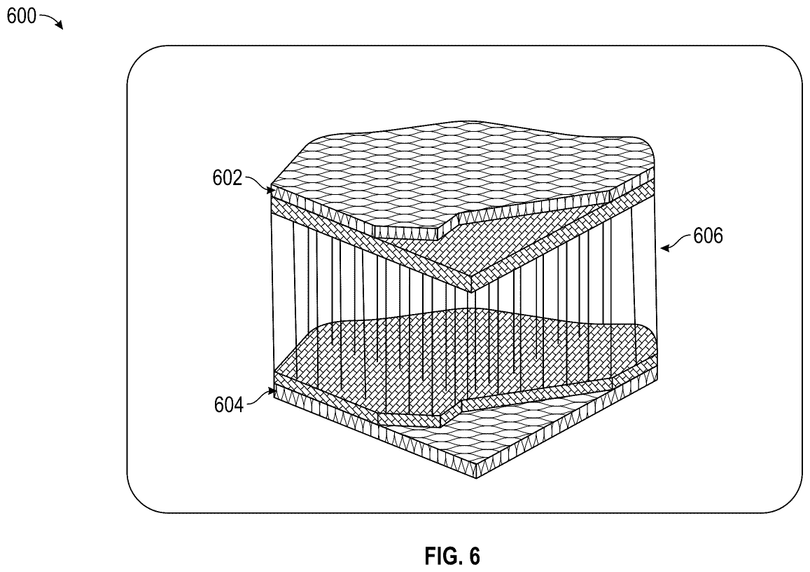

FIG. 6 is a diagram 600 depicting a drop stitch material, according to certain examples. According to certain examples described above, an inflatable component features an air chamber constructed using drop stitch material, comprising two outer layers linked by interwoven yarns, enabling the component to preserve its form and rigidity upon inflation, withstanding the elevated pressures encountered during the operation of a vehicle. As seen in the diagram 600 the drop stitch material comprises two distinct layers, layer 602 and 604, and a series of woven yarns, indicated as 606. These components together form the foundational structure of the inflatable aerodynamic deflector.

Layer 602 represents one of the parallel fabric layers that make up the outer surface of the drop stitch material. This layer can be constructed from various durable and flexible materials suitable for withstanding the forces encountered during vehicular movement and exposure to environmental elements.

Layer 604 is the second of the parallel fabric layers, positioned opposite to layer 602, and together with layer 602, it encapsulates the woven yarns 606. Layer 604 is similarly made from a robust and flexible material, and it may have properties that complement or mirror those of layer 602 to ensure uniform inflation and structural stability.

The length of the yarns 606 determines the distance between the two layers, and thus, to the thickness of the inflatable aerodynamic deflector. Accordingly, by varying the length of the yarns 606, the thickness of the resulting inflatable component can be customized. Shorter yarns will result in a thinner component, while longer yarns will produce a thicker component. This variability allows for the creation of inflatable components with different profiles and aerodynamic characteristics to suit specific applications or to conform to the contours of various vehicle designs.

According to certain example, the connecting yarns, also referred to as threads, are woven between the two outer layers, or skins, ensuring a consistent separation between them. For example, the yarns may be placed between the skins and affixed at specific locations.

### EXAMPLES

Example 1: An inflatable component to reduce aerodynamic drag of a conveyance comprising a drop stitch material forming an air chamber of the inflatable component, the drop stitch material comprising a pair of skins connected by yarns extending between the pair of skins; an inflation valve coupled to the inflatable component to facilitate inflation and deflation of the air chamber of the inflatable component; and one or more connectors distributed at or adjacent a perimeter of the inflatable component and configured to engage with one or more corresponding fixtures of the conveyance.

Example 2: The subject matter of Example 1, further comprising at least one contour edge formed by the drop stitch material.

Example 3: The subject matter of Example 1 or 2, wherein the pair of parallel skins comprise a first skin and a second skin, and wherein an area of the first skin is greater than an area of the second skin.

Example 4: The subject matter of Examples 1-3, wherein the contour edge is formed by varying a thread pitch of the yarns within the drop stitch material such that a distance between the yarns varies at predetermined locations to form the contour edge.

Example 5: The subject matter of Examples 1-4, wherein the contour edge is formed by a cutaway of a skin from among the pair of skins of the drop stitch material.

Example 6: The subject matter of Examples 1-5, wherein the inflatable component comprises a leading edge and a trailing edge, and wherein a thickness of the inflatable component at the leading edge is less than the thickness of the inflatable component at the trailing edge.

Example 7: The subject matter of Examples 1-6, wherein the thickness of the inflatable component is defined by a yarn length of the yarns woven between the pair of parallel skins.

Example 8: The subject matter of Examples 1-7, wherein the inflatable component further comprises a planar form defined by the air chamber formed of the pair of skins.

Example 9: The subject matter of Examples 1-8, wherein the inflatable component further comprises a pair of contoured edges, and wherein the pair of contoured edges are aligned with a central longitudinal axis of the inflatable component.

Example 10: The subject matter of Examples 1-9, wherein the connectors are located at towards a leading edge of the inflatable component for operatively connecting to the one or more corresponding fixtures are located at a forward end of the conveyance, to operatively reduce aerodynamic resistance of the forward end of the conveyance.

Example 11: The subject matter of Examples 1-10, wherein the connectors are located out or towards a trailing edge of the inflatable component for operatively connecting to the one or more corresponding fixtures are located at the rearward end of the conveyance, to operatively reduce aerodynamic resistance of the rearward end of the conveyance.

Example 12: The subject matter of any one of Examples 1-11, further comprising a deployment mechanism that comprises a furling drum that comprises an internal furling foil, and wherein the inflatable component is fixed to the furling foil and configured to extend and retract into the furling drum based on a rotation of the furling foil.

Example 13: The subject matter of any one of Examples 1-12, wherein the furling foil comprises a conical rail.

Example 14: The subject matter of any one of Examples 1-13, further comprising a vertical dimension and a height adjustment mechanism that comprises a concavo-convex structure configured to transition between one or more states that include an extended state and a retracted state, and wherein the vertical dimension of the inflatable component is based on the one or more states of the concavo-convex structure.

Example 15: The subject matter of any one of Examples 1-14, wherein a skin from among the pair of parallel skins comprises a translucent skin, and wherein the inflatable component further comprises a lighting system.

Example 16: The subject matter of any one of Examples 1-15, further comprising one or more attachment interfaces that include one or more of: a rail system; one or more magnetic fasteners; one or more quick disconnect clips; one or more dovetail joints; one or more snap fasteners; and one or more buckles and clips.

Example 17: The subject matter of any one of Examples 1-17, further comprising a pressure regulation mechanism that includes an air compressor.

Example 18: The subject matter of any one of Examples 1-17, wherein the inflatable component comprises an aerodynamic deflector.

Example 19: The subject matter of any one of Examples 1-18, wherein the conveyance includes a combination vehicle that comprises a tow vehicle and a trailer.

Example 20: The subject matter of Examples 1-19, wherein the air chamber comprises a plurality of air chambers.

Example 21: An apparatus comprising means to perform one or more elements of a method described in or related to any of Examples 1-20 or any other method or process described herein.

What is claimed is:

1. An inflatable component to reduce aerodynamic drag of a conveyance comprising:
a drop stitch material forming an air chamber of the inflatable component, the drop stitch material comprising a pair of skins connected by yarns extending between the pair of skins;
an inflation valve coupled to the inflatable component to facilitate inflation and deflation of the air chamber of the inflatable component; and
one or more connectors distributed at or adjacent a perimeter of the inflatable component and configured to engage with one or more corresponding fixtures of the conveyance.

2. The inflatable component of claim 1, further comprising at least one contour edge formed by the drop stitch material.

3. The inflatable component of claim 2, wherein the pair of parallel skins comprise a first skin and a second skin, and wherein an area of the first skin is greater than an area of the second skin.

4. The inflatable component of claim 2, wherein the contour edge is formed by varying a thread pitch of the yarns within the drop stitch material such that a distance between the yarns varies at predetermined locations to form the contour edge.

5. The inflatable component of claim 2, wherein the contour edge is formed by a cutaway of a skin from among the pair of skins of the drop stitch material.

6. The inflatable component of claim 1, wherein the inflatable component comprises a leading edge and a trailing edge, and wherein a thickness of the inflatable component at the leading edge is less than the thickness of the inflatable component at the trailing edge.

7. The inflatable component of claim 6, wherein the thickness of the inflatable component is defined by a yarn length of the yarns woven between the pair of parallel skins.

8. The inflatable component of claim 1, wherein the inflatable component further comprises a planar form defined by the air chamber formed of the pair of skins.

9. The inflatable component of claim 1, wherein the inflatable component further comprises a pair of contoured edges, and wherein the pair of contoured edges are aligned with a central longitudinal axis of the inflatable component.

10. The inflatable component of claim 1, wherein the connectors are located at towards a leading edge of the inflatable component for operatively connecting to the one or more corresponding fixtures are located at a forward end of the conveyance, to operatively reduce aerodynamic resistance of the forward end of the conveyance.

11. The inflatable component of claim 1, wherein the connectors are located out or towards a trailing edge of the inflatable component for operatively connecting to the one or more corresponding fixtures are located at a rearward end of the conveyance, to operatively reduce aerodynamic resistance of the rearward end of the conveyance.

12. The inflatable component of claim 1, further comprising a deployment mechanism that comprises a furling drum that comprises an internal furling foil, and wherein the inflatable component is fixed to the furling foil and configured to extend and retract into the furling drum based on a rotation of the furling foil.

13. The inflatable component of claim 12, wherein the furling foil comprises a conical rail.

14. The inflatable component of claim 1, further comprising a vertical dimension and a height adjustment mechanism that comprises a concavo-convex structure configured to transition between one or more states that include an extended state and a retracted state, and wherein the vertical dimension of the inflatable component is based on the one or more states of the concavo-convex structure.

15. The inflatable component of claim 1, wherein a skin from among the pair of parallel skins comprises a translucent skin, and wherein the inflatable component further comprises a lighting system.

16. The inflatable component of claim 1, wherein the inflatable component comprises one or more attachment interfaces include one or more of:
a rail system;
one or more magnetic fasteners;
one or more quick disconnect clips;
one or more dovetail joints;
one or more snap fasteners; and
one or more buckles and clips.

17. The inflatable component of claim 1, further comprising a pressure regulation mechanism that includes an air compressor.

18. The inflatable component of claim 1, wherein the inflatable component comprises an aerodynamic deflector.

19. The inflatable component of claim 1, wherein the conveyance includes a combination vehicle that comprises a tow vehicle and a trailer.

20. The inflatable component of claim 1, wherein the air chamber comprises a plurality of air chambers.
